(19) United States
(12) Patent Application Publication
(10) Pub. No.: US 2024/0020615 A1
(43) Pub. Date: Jan. 18, 2024

(54) SYSTEM AND METHOD FOR EVALUATING DIGITAL SERVICE

(71) Applicant: ISKY RESEARCH PTE. LTD., Singapore (SG)

(72) Inventor: Mark Donohue, Reading (GB)

(21) Appl. No.: 18/476,610

(22) Filed: Sep. 28, 2023

Related U.S. Application Data
(63) Continuation-in-part of application No. 17/212,343, filed on Mar. 25, 2021, now abandoned.

(51) Int. Cl. G06Q 10/0639

(52) U.S. Cl. CPC G06Q 10/06393

(57) ABSTRACT

Disclosed is a method for evaluating a digital service. The method comprises defining, via processor, benchmarks for plurality of service categories; defining, via the processor, at least two options for each of the benchmarks; defining, via the processor, a weight value for each of the at least two options; receiving, via the processor, responses in the form of selection of one of the at least two options; calculating, via the processor, a weighted total value for each benchmark; determining, via the processor, if a particular functionality related with one of the benchmarks is available; assigning, via the processor, a benchmark value to each benchmark equal to the calculated weighted total value for the corresponding benchmark of the benchmarks if the particular functionality is available; and calculating, via the processor, a digital service score based on a sum of the assigned benchmark values and a sum of the weighted total value.

### TECHNICAL FIELD

The present disclosure relates generally to scoring mechanisms and more specifically, to a system and a method for evaluating a digital service.

### BACKGROUND

Digital services such as digital banking services need a scoring mechanism. The digital banking service may be scored according to customer experiences. Such a scoring mechanism may help customers in selecting one digital banking service over another digital banking service. The scoring mechanism may also assist providers of the digital banking service in gaining an insight into customer needs and knowing how much the respective digital banking service caters to customer needs. According to the score, the providers may add or remove certain functionalities in the digital banking service in order to improve customer experience.

Conventional scoring mechanisms are biased, flawed and do not provide reliable scores. Bias in the conventional scoring mechanisms makes it difficult for customers to choose an appropriate digital banking service. Also, the providers may not get the correct insight into their digital banking service. Furthermore, the providers may not be able to learn about their industry and hence, they may not be able to improve their digital banking service in order to keep pace with their competitors. The lack of an efficient, unbiased scoring methodology for digital services, such as the digital banking services, makes it difficult to make meaningful improvements to the digital service as per the customer's needs. Data security is also important when implementing scoring mechanisms, in particular anonymity of users providing feedback for scoring purposes. It will be appreciated that data security is regarded as being a technical effect.

Therefore, in light of the foregoing discussion, there exists a need to overcome the aforementioned drawbacks associated with tools for evaluating the digital service.

### SUMMARY

An object of the present disclosure is to provide a system and a method for evaluating a digital service. Another object of the present disclosure is to provide a solution that overcomes at least partially the problems encountered in the prior art.

In one aspect, an embodiment of the present disclosure provides, a method for evaluating a digital service, the method comprising:
defining, via a processor, one or more benchmarks for one or more of a plurality of service categories associated with the digital service, each of the one or more benchmarks related to a functionality offered by corresponding service category of the plurality of service categories from perspective of a user;
defining, via the processor, at least two options for each of the one or more benchmarks, with one of the at least two options to be selected as a response by a user for each of the one or more benchmarks as an indicator of importance of the functionality offered by the related benchmark of the one or more benchmarks from perspective of the said user;
defining, via the processor, a weight value for each of the at least two options proportional to an importance of the functionality offered by the related benchmark of the one or more benchmarks from perspective of a user;
receiving, via the processor, from a plurality of users, responses in the form of selection of one of the at least two options for each of the one or more benchmarks;
processing, via the processor, the responses received from the plurality of users for each of the one or more benchmarks based on at least the defined weight values of the selected at least two options and the associated service category to determine relationships between the one or more benchmarks, or between at least one of the one or more benchmarks and the corresponding service category;
determining, via the processor, a weight factor for each of the one or more benchmarks based on the determined relationships between the one or more benchmarks, or between at least one of the one or more benchmarks and the corresponding service category;
calculating, via the processor, a weighted total value for each of the one or more benchmarks based on the received responses and the defined weight values for the at least two options thereof;
determining, via the processor, if a particular functionality related with one of the benchmarks of the one or more benchmarks is available in the digital service;
assigning, via the processor, a benchmark value to each of the one or more benchmarks equal to the calculated weighted total value for the corresponding one of the one or more benchmarks if the related particular functionality thereto is determined to be available in the digital service; and
calculating, via the processor, a digital service score for the digital service based on a sum of the assigned benchmark values for the one or more benchmarks and a sum of the weighted total value for the one or more benchmarks.

In one aspect, an embodiment of the present disclosure provides, a system for evaluating a digital service, the system comprising a processor configured to:
define one or more benchmarks for one or more of a plurality of service categories associated with the digital service, each of the one or more benchmarks related to a functionality offered by corresponding service category of the plurality of service categories from perspective of a user;
define at least two options for each of the one or more benchmarks, with one of the at least two options to be selected as a response by a user for each of the one or more benchmarks as an indicator of importance of the functionality offered by the related benchmark of the one or more benchmarks from perspective of the said user;
define a weight value for each of the at least two options proportional to an importance of the functionality offered by the related benchmark of the one or more benchmarks from perspective of a user;
receive, from a plurality of users, responses in the form of selection of one of the at least two options for each of the one or more benchmarks;
process the responses received from the plurality of users for each of the one or more benchmarks based on at least the defined weight values of the selected at least two options and the associated service category to determine relationships between the one or more benchmarks, or between at least one of the one or more benchmarks and the corresponding service category;
determine a weight factor for each of the one or more benchmarks based on the determined relationships between the one or more benchmarks, or between at least one of the one or more benchmarks and the corresponding service category;
calculate a weighted total value for each of the one or more benchmarks based on the received responses and the defined weight values for the at least two options thereof;
determine if a particular functionality related with one of the benchmarks of the one or more benchmarks is available in the digital service;
assign a benchmark value to each of the one or more benchmarks equal to the calculated weighted total value for the corresponding one of the one or more benchmarks if the related particular functionality thereto is determined to be available in the digital service; and
calculate a digital service score for the digital service based on a sum of the assigned benchmark values for the one or more benchmarks and a sum of the weighted total value for the one or more benchmarks.

Embodiments of the present disclosure substantially eliminate or at least partially address the aforementioned problems in the prior art, and enable efficient evaluation of the digital service.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF DRAWINGS

Embodiments of the present disclosure will now be described, by way of example only, with reference to the following diagrams wherein:

FIG. 1 is a flowchart listing steps involved in a method for evaluating a digital service, in accordance with an embodiment of the present disclosure; and

FIG. 2 is a block diagram illustration of a system for evaluating the digital service, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides, a method for evaluating a digital service, the method comprising:
defining, via a processor, one or more benchmarks for one or more of a plurality of service categories associated with the digital service, each of the one or more benchmarks related to a functionality offered by corresponding service category of the plurality of service categories from perspective of a user;
defining, via the processor, at least two options for each of the one or more benchmarks, with one of the at least two options to be selected as a response by a user for each of the one or more benchmarks as an indicator of importance of the functionality offered by the related benchmark of the one or more benchmarks from perspective of the said user;
defining, via the processor, a weight value for each of the at least two options proportional to an importance of the functionality offered by the related benchmark of the one or more benchmarks from perspective of a user;
receiving, via the processor, from a plurality of users, responses in the form of selection of one of the at least two options for each of the one or more benchmarks;
processing, via the processor, the responses received from the plurality of users for each of the one or more benchmarks based on at least the defined weight values of the selected at least two options and the associated service category to determine relationships between the one or more benchmarks, or between at least one of the one or more benchmarks and the corresponding service category;
determining, via the processor, a weight factor for each of the one or more benchmarks based on the determined relationships between the one or more benchmarks, or between at least one of the one or more benchmarks and the corresponding service category;
calculating, via the processor, a weighted total value for each of the one or more benchmarks based on at least one of the received responses, the determined weight factor, and the defined weight values for the at least two options thereof;
determining, via the processor, if a particular functionality related with one of the benchmarks of the one or more benchmarks is available in the digital service;
assigning, via the processor, a benchmark value to each of the one or more benchmarks equal to the calculated weighted total value for the corresponding one of the one or more benchmarks if the related particular functionality thereto is determined to be available in the digital service; and
calculating, via the processor, a digital service score for the digital service based on a sum of the assigned benchmark values for the one or more benchmarks and a sum of the weighted total value for the one or more benchmarks.

In another aspect, an embodiment of the present disclosure provides, a system for evaluating a digital service, the system comprising a processor configured to:
define one or more benchmarks for one or more of a plurality of service categories associated with the digital service, each of the one or more benchmarks related to a functionality offered by corresponding service category of the plurality of service categories from perspective of a user;
define at least two options for each of the one or more benchmarks, with one of the at least two options to be selected as a response by a user for each of the one or more benchmarks as an indicator of importance of the functionality offered by the related benchmark of the one or more benchmarks from perspective of the said user;
define a weight value for each of the at least two options proportional to an importance of the functionality offered by the related benchmark of the one or more benchmarks from perspective of a user;
receive, from a plurality of users, responses in the form of selection of one of the at least two options for each of the one or more benchmarks;
process the responses received from the plurality of users for each of the one or more benchmarks based on at least the defined weight values of the selected at least two options and the associated service category to determine relationships between the one or more benchmarks, or between at least one of the one or more benchmarks and the corresponding service category;
determine a weight factor for each of the one or more benchmarks based on the determined relationships between the one or more benchmarks, or between at least one of the one or more benchmarks and the corresponding service category;
calculate a weighted total value for each of the one or more benchmarks based on at least one of the received responses, the determined weight factor, and the defined weight values for the at least two options thereof;
determine if a particular functionality related with one of the benchmarks of the one or more benchmarks is available in the digital service;
assign a benchmark value to each of the one or more benchmarks equal to the calculated weighted total value for the corresponding one of the one or more benchmarks if the related particular functionality thereto is determined to be available in the digital service; and
calculate a digital service score for the digital service based on a sum of the assigned benchmark values for the one or more benchmarks and a sum of the weighted total value for the one or more benchmarks.

The present disclosure relates to a method and a system for evaluating a digital service. The aforementioned method and the aforementioned system for evaluating a digital service is used to provide an unbiased, reliable and accurate digital service score for the digital service, by defining the one or more benchmarks for one or more of a plurality of service categories while taking into account responses from the plurality of users. Beneficially, the digital score calculated for the digital service facilitates each of the plurality of users to gain insight into the digital service, and consequently to make an informed decision associated with the digital service as per requirements of each of the plurality of users. The weight value for each of the at least one option enables the determination of an importance of the functionality, while taking into account several factors affecting the digital service score. Furthermore, the one or more benchmarks serve as measurable reference points against which the functionality offered by one or more of the plurality of service categories are evaluated in an unbiased and accurate manner which users may rely on to make informed decisions and thereby improve the overall user experience with digital banking

Herein, the digital service may refer to delivering information via platforms, such as for example, a website or a mobile application. The digital service replaces the use of paper forms and thus provides services in a digital manner, which helps facilitate a user to access information related to an organization as well as protecting user identity, thereby improving user confidentiality and impartiality in the scoring. Hence, users may access the information at the comfort of their homes without having to go to offices of the respective service provider. For example, by using a digital banking service, users may not have to fill in paper forms or any other physical documentary requirements, and submit it at a bank for gaining an insight of their account balance, transactions and the likes. The user may simply access the information by logging into the website or the mobile application. As may be understood, the digital service may be delivered via a digital service channel and thereby requires delivery via a computer medium, such as, but not limited to, the mobile application and the webpage, by which the digital service is provided to a plurality of users and thus, also provides an eco-friendly alternative to using paper.

For explanatory purposes of the present disclosure, hereinafter, the “digital services” has been described in terms of “digital banking services”, without any limitations. However, it may be appreciated that the teachings of the present disclosure may be applied to any digital services apart from the digital banking services. Examples of the digital services may include, but are not limited to, cloud computing, digital commerce and finance, digital learning, digital publications, digital streaming, digital data management, digital data processing, and digital gaming.

The method comprises defining, via a processor, one or more benchmarks for one or more of a plurality of service categories associated with the digital service. The term “benchmark” as used herein refers to a quantitative quality standard defined for a given service category based on a plurality of factors including at least one of historically-defined benchmarks, rules and/or regulations associated with the digital services, customer service norms, or customized based on current user requirements. For example, if one or more benchmarks are set for a given data rule, all statistics from the rule mayof the plurality of service categories associated with the digital service. Notably, each of the one or more benchmarks relate to a functionality offered by a corresponding service category of the plurality of service categories from the perspective of a user. The one or more benchmarks are defined as specific, measurable entities that may be customised based on the functionality offered by a corresponding service category, and optionally, a priority of each service category of the plurality of service categories. Moreover, the one or more benchmarks for the one or more of the plurality of service categories associated with the digital service are measurable in a digital manner. It will be appreciated that the plurality of digital service categories and the associated one or more benchmarks may vary depending on the offered digital service without any limitations. Additionally, the plurality of service categories and the associated one or more benchmarks enable the method to score or evaluate products or business units as well apart from the digital service and thereby exhibits the versatility and importance of the method industrywide.

The one or more benchmarks may be defined for the plurality of service categories for various practical use case scenarios. In a first exemplary use case scenario, the plurality of service categories may be associated with the digital banking services of a digital banking service provider (hereafter referred to as a “digital bank”). The plurality of service categories may be at least one of: “transaction processing speed”, “security measures”, “customer support response time”. When the service category is the “transaction processing speed”, a benchmark may be to process a given customer's transaction within 5 seconds. This benchmark may measure how quickly the digital bank processes transactions, such as fund transfers or bill payments. When the service category is “security measures”, a benchmark may be to achieve a cybersecurity rating of 80 on a scale of 0 to 100, which indicates a strong level of security. This benchmark may assess an ability of the digital bank to maintain a high level of security in protecting customer's data and transactions. When the service category is “customer support response time”, a benchmark may be responding to customer inquiries within 2 minutes. This benchmark may measure how efficiently a customer support team of the digital bank handles and resolves customer issues.

In a second exemplary use case scenario, the plurality of service categories may be associated with digital learning provided by a digital learning platform. The plurality of service categories may be at least one of: “course completion rate”, “user satisfaction score”, “content update frequency”. When the service category is the “course completion rate”, a benchmark may be to achieve a course completion rate of 50%. This benchmark may evaluate how effectively a digital learning platform keeps learners engaged and motivated to complete their courses. When the service category is the “user satisfaction score”, a benchmark may be to maintain a user satisfaction score of 7 on a scale of 0 to 10, which indicates that the user is moderately satisfied. This benchmark may gauge an overall satisfaction of the users with at least one: an interface, content, and features of the digital learning platform. When the service category is the “content update frequency”, a benchmark may be to assess a commitment of the digital learning platform to keep the content updated and relevant.

In a third exemplary use case scenario, the plurality of service categories may be associated with digital gaming on a digital gaming platform. The plurality of service categories may be at least one of: “latency and ping rate”, “game performance and graphics”, “game update frequency”. When the service category is the “latency and ping rate”, a benchmark may be to maintain an average latency of 40 milliseconds and a ping rate of 50 milliseconds when the digital gaming is implemented for online multiplayer games. When the service category is the “game performance and graphics”, a benchmark may be to achieve a frame rate of 60 frames per second (FPS) at a resolution of 720 pixels for graphics-intensive games. When the service category is the “game update frequency”, a benchmark may be to release updates and patches at least once every 2 weeks. This benchmark may evaluate how frequently game developers developing content on the digital gaming platform provide improvements, bug fixes, and new content to keep users engaged.

In an embodiment, the one or more benchmarks may relate to performance and efficiency of actions that each of the plurality of users can take while using the digital services. A technical effect of the one or more benchmarks is to ensure that the digital services are reliable, fast, and user-friendly. In this regard, meeting or exceeding the one or more benchmarks indicates that the digital services provide efficient and convenient services to the plurality of users. Herein, particular values of each of the one or more benchmarks are optionally varied based on a capability of a provider of the digital services and industry standards related to the digital services.

Continuing in reference to the first exemplary use case scenario, the plurality of service categories may further be at least one of: “transaction processing time”, “account balance retrieval”, “access to statements”, “transaction history”, “card management (e.g., block, cancel, order new card)”, “virtual card issuance”, “peer-to-peer payments”, “bill payment confirmation”, “QR code scanning and payment”. When the service category is the “transaction processing time”, a benchmark may be to complete a fund transfer or bill payment within 30 seconds. As an exemplary value, 95% of transactions should meet this benchmark. When the service category is the “account balance retrieval”, a benchmark may be to display the account balance within 2 seconds of the request. As an exemplary value, 99% of balance inquiries should meet this benchmark. When the service category is the “access to statements”, a benchmark may be to allow customers to access monthly statements within 1 minute. As an exemplary value, 90% of statement requests should meet this benchmark. When the service category is the “transaction history”, a benchmark may be to display the last 10 transactions within 5 seconds. As an exemplary value, 95% of transaction history requests should meet this benchmark. When the service category is the “card management (e.g., block, cancel, order new card)”, a benchmark may be to complete card management actions within 2 minutes. As an exemplary value, 98% of card management requests should meet this benchmark. When the service category is the “virtual card issuance”, a benchmark may be to issue a virtual card within 5 minutes. As an exemplary value, 90% of virtual card issuance requests should meet this benchmark. When the service category is the “peer-to-peer payments”, a benchmark may be to process a person-to-person payment within 10 seconds. As an exemplary value, 95% of peer-to-peer payments should meet this benchmark. When the service category is the “bill payment confirmation”, a benchmark may be to provide a payment receipt within 1 minute of bill payment. As an exemplary value, 99% of bill payment receipts should meet this benchmark. When the service category is the “QR code scanning and payment”, a benchmark may be to successfully process a QR code payment within 15 seconds. As an exemplary value, 95% of QR code payments should meet this benchmark.

Herein, the ‘processor’ (or the data processor) refers to a structure and/or module that includes programmable and/or non-programmable components configured to store, process and/or share information and/or signals for evaluating a digital service. Alternatively stated, the processor refers to a computational element that is operable to respond to and processes instructions to evaluate the digital service. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, Field Programmable Gate Array (FPGA) or any other type of processing circuit, for example as aforementioned. Furthermore, it will be appreciated that the processor may be implemented as a hardware processor and/or plurality of hardware processors operating in a parallel or in a distributed architecture. Optionally, the processor is supplemented with additional computation systems, such as neural networks, and hierarchical clusters of pseudo-analog variable state machines implementing artificial intelligence algorithms. Optionally, the processor may be a hardware server, or a cloud server, or an architecture thereof. Optionally, the processor may be a part of cloud server architecture such as a content delivery network (CDN), for allowing quick transfer of information required for evaluating the digital service based on responses from a large number of users.

Typically, the processor is operable to perform one or more operations for evaluating the digital service. In the present examples, the processor may include components such as memory, a network adapter and the like, to store, process and/or share information with other computing components, such as a user device, a remote server unit, a database arrangement. Optionally, the processor includes any arrangement of physical or virtual computational entities capable of enhancing information to perform various computational tasks. Optionally, the processor is implemented as a computer program that provides various services (such as database service) to other devices, modules or apparatus.

Herein, the processor may communicate with each other computational elements using a communication interface. The communication interface includes a medium (e.g., a communication channel) through which the system components communicate with each other. Examples of the communication interface include, but are not limited to, a communication channel in a computer cluster, a Local Area Communication channel (LAN), a cellular communication channel, a wireless sensor communication channel (WSN), a cloud communication channel, a Metropolitan Area Communication channel (MAN), and/or the Internet. Optionally, the communication interface comprises one or more of a wired connection, a wireless network, cellular networks such as 2G, 3G, 4G, 5G mobile networks, and a Zigbee connection.

The method further comprises defining, via the processor, at least two options for each of the one or more benchmarks, with one of the at least two options to be selected as a response by a user for each of the one or more benchmarks as an indicator of importance of the functionality offered by the related benchmark of the one or more benchmarks from perspective of the said user. As discussed, one or more benchmarks may be a question queried from the user, to determine the at least two options or a value of each of the at least two options. Typically, the at least two options enable qualitative assessment of each of the one or more benchmarks based on the user responses, and may be varied based on the type of digital service, or customized based on past user responses. Moreover, the number of the at least two options may be varied based on the type of benchmark, such as, for example, the at least two options may include two options for the benchmark, functionality offered, as either “yes” or “no”. In another example, wherein the benchmark is the level of satisfaction associated with a given digital service, the at least two options may be provided as a numerical scale of 1 to 10, or 1 to 100. In other examples, each of the one or more benchmarks may include the at least two options such as, but not limited to, very important, important, neutral, not important and not at all important, which may indicate the importance of the functionality offered by the one or more benchmarks to the user. Optionally, the at least two options may be presented as a numerical scale such as, a nominal scale, ordinal scale, interval scale, ratio scale, etc., or received directly as text or numerical value. A technical effect of defining the at least two options for each of the one or more benchmarks is to enable qualitative and quantitative assessment of the corresponding benchmark and thus, the evaluation of the digital service, at a granular level, in an effective and unbiased manner.

In an embodiment, the user selects any one of the at least two options. The user may be allowed to define one or more of the at least two options to provide a more realistic and unbiased evaluation via the method. A technical effect of the user selecting any one of the at least two options is that it enables defining the one or more benchmarks for one or more of the plurality of service categories associated with the digital service, and evaluating the digital service in a customizable manner while taking user preferences into account during evaluation. Moreover, the method beneficially allows the users to select, which benchmark of the one or more benchmarks for one or more of the plurality of service categories is/are important for the given user, a level of importance of the selected benchmark, or define new benchmarks altogether. Consequently, conclusions made after the user selects any one of the at least two options is useful for both the user and the provider of the digital service. For example, in an embodiment, each one or more benchmarks may include five options: very important, important, neutral, not important and not at all important. The user may select ‘very important’ if the user thinks that respective benchmark has critical relevance and must be included in the digital service. The user may select ‘not important’ if the user thinks that the respective benchmark has very low relevance and may not necessarily be included in the digital service. For example, for the digital service related to the bank, the user may select ‘very important’ option for the benchmark “see account balance”, and ‘not important’ option for the benchmark “QR codes”.

The method further comprises defining, via the processor, a weight value for each of the at least two options proportional to an importance of the functionality offered by the related benchmark of the one or more benchmarks from the perspective of a user. As discussed, the at least two options may indicate how important the one or more benchmarks is to the user. In order to distinguish the importance of each of the at least two options, the weight value may be assigned to each of the at least two options. The weight values may be any numerical value. A relationship between the weight values and an importance of each of the weight values can be determined, for example, in a lookup table. In this regard, when the user has selected one of the at least two options, then the weight value of the selection option is fetched from the lookup table. The option which indicates that the benchmark is most important may be assigned the highest weight value and the option which indicates that the benchmark is least important may be assigned the lowest weight value. For example, in an embodiment, when the one or more benchmarks may include very important, important, neutral, not important and not at all important as the options; herein, the weight value assigned to the option ‘very important’ may be ‘5’, the weight value assigned to the option ‘important’ may be ‘4’, the weight value assigned to the option ‘neutral’ may be ‘3’, the weight value assigned to the option ‘not important’ may be ‘2’ and the weight value assigned to the option ‘not at all important’ may be ‘1’. It will be appreciated that the weight value of each of the at least two options may be determined by other statistical techniques or data, without any limitations.

In an embodiment, the weight value for a given option is set based on historical data associated with the at least two options selected by the plurality of users for each of the one or more benchmarks, and/or on historical benchmark data. A technical effect of selecting the given option in such a manner is to enable impartial evaluation based on historical benchmarking and scoring that users are more accustomed with in order to improve the user experience. Moreover, to enable determination of the one or more benchmarks and evaluation thereof, that are currently in use, in an effective and efficient manner.

The method further comprises receiving, via the processor, from a plurality of users, responses in the form of selection of one of the at least two options for each of the one or more benchmarks. Typically, the responses are received from the plurality of users as a selection of the at least two options, wherein the plurality of users may be prior users of the given digital service, or experts on a given digital service, and the like. Optionally, the responses include text inputted by the user and may be further analysed to either fit the at least two options, or defined as another option altogether via the processor. Moreover, the responses may be received from the plurality of users to perform at least one action, for example, enabling further analysis, assessment, evaluation or making informed decisions, based on the responses from the plurality of users. For example, a benchmark may be “a speed of switching between two applications”. Herein, at least two options for the benchmark may be any one of: low, moderate, high. Subsequently, a response that may be received from two users may be “low”, which means that the two users may consider an importance of the benchmark to be low.

In an embodiment, the plurality of users may be a plurality of customers whose perspective may be taken into account to improve customer experience for the digital service. In order to gain perspective of the plurality of users, ‘user needs analysis survey’ may be run for the plurality of users. Each of the users may select one of the at least two options for each of the one or more benchmarks according to his/her perspective. Referring to ‘Table 1’, responses of an exemplary ‘user-needs analysis survey’ are provided. Continuing in reference with the first exemplary use case scenario, five options may be defined for each of the one or more benchmarks: “very important” having the weight value 5, “important” having the weight value 4, “neutral” having the weight value 3, “not important” having the weight value 2, and “not at all important” having the weight value 1. The plurality of users comprises thirty users. Each of the plurality of users take a ‘user-needs analysis survey’ and may select one of the at least two options for each of the one or more benchmarks in each of the service categories on a scale of “very important” to “not at all important”. For example, it may be observed from the ‘Table 1’ that fifteen users have selected “very important”, three users have selected “important”, one user has selected “neutral”, four users have selected “not important”, and seven users have selected “not at all important for the benchmark in the service category “account balance retrieval”.

TABLE 1

| | | Very | | | Not | Not at all | |
|---|---|---|---|---|---|---|---|
| | Weight | important | Important | Neutral | important | important | |
| | value | 5 | 4 | 3 | 2 | 1 | Total |
| First | See account | 15 | 3 | 1 | 4 | 7 | 30 |
| service | balance | | | | | | |
| category | Access | 2 | 8 | 5 | 10 | 5 | 30 |
| | statements | | | | | | |
| | See | 7 | 5 | 8 | 6 | 4 | 30 |
| | transactions | | | | | | |
| | Change | 2 | 6 | 15 | 6 | 1 | 30 |
| | statement | | | | | | |
| | delivery | | | | | | |
| Second | Block Card | 5 | 7 | 5 | 8 | 5 | 30 |
| service | Cancel card | 8 | 2 | 8 | 8 | 4 | 30 |
| category | Order new | 4 | 3 | 3 | 5 | 15 | 30 |
| | card | | | | | | |
| | Virtual Card | 6 | 6 | 2 | 15 | 1 | 30 |
| Third | Pay someone | 0 | 8 | 2 | 5 | 15 | 30 |
| Service | Pay a bill | 5 | 8 | 1 | 4 | 12 | 30 |
| category | Payment | 7 | 3 | 7 | 8 | 5 | 30 |
| | receipt | | | | | | |
| | QR codes | 8 | 9 | 4 | 5 | 4 | 30 |

The method further comprises processing, via the processor, the responses received from the plurality of users for each of the one or more benchmarks based on at least the defined weight values of the selected at least two options and the associated service category to determine relationships between the one or more benchmarks, or between at least one of the one or more benchmarks and the corresponding service category. Herein, the responses received from the plurality of users for each of the one or more benchmarks are processed and analysed based on at least the defined weight values of the selected at least two options and the associated service category. Moreover, the received responses may be processed to infer patterns or relationships between the received responses and the one or more benchmarks based on at least one of the defined weight values of the selected at least two options, the type of the digital service, or user input. In an example, the determined relationships between the one or more benchmarks may include an ordered list of the one or more benchmarks based on relevance or importance for a given service category of the plurality of service categories as derived from the processed responses. The received responses may be processed via at least one statistical technique selected from at least one of cross tabulation, lookup table, correlation analysis, multiple regressions, t-tests, variance analysis, chi-square tests, and the like, to enable accurate determination of relationships between at least one of the one or more benchmarks and the associated service category, or between at least the one or more benchmarks. Additionally, optionally, the processing of the received responses, via the processor, allows the method to filter insightful responses from the received responses received from the plurality of users to enable processing, evaluation, and/or analysis of the received responses in a quick and accurate manner. However, in this manner of processing, an individual identity of user providing response are kept anonymous, even when determining relationships between the responses.

The method further comprises assigning, via the processor, a weight factor for each of the one or more benchmarks based on the determined relationships between at least two of the one or more benchmarks, or between at least one of the one or more benchmarks and the corresponding service category. Optionally, the assignment of weight factor may be done similar to the definition of the weight value for the at least two options for each of the one or more benchmarks. In an embodiment, the assignment is done by assigning a higher weightage to important (or relevant) benchmarks and a lower weightage to irrelevant or less important benchmarks as inferred from the determined relationships. Alternatively stated, the weight factor may be assigned based on the importance of a relevant benchmark for a given service category of the plurality of service categories. The assignment of the weight factor may be done based on the determined relationships and other factors such as, a number, or frequency, or magnitude, of one or more responses of the received responses from the plurality of users. Beneficially, the determined relationships enables assignment of the weight factor for each of the one or more benchmarks, wherein the weight factor further allows the method to accurately determine weighted total values for each benchmark as explained later on in the present disclosure. Assigning weight factors to the benchmarks and not to individual users providing responses enables user data protection to be enhanced, thereby providing data security to the system.

The method further comprises calculating, via the processor, a weighted total value for each of the one or more benchmarks based on at least one of the received responses, the and the defined weight values for the at least two options thereto. In this regard, an output of calculating the weighted total value for each of the one or more benchmarks is a function of a sum of a multiplication (i.e., a summing multiplication or a sum product) of the weight value for each of the at least two options and a number of users of the plurality of users that have selected the respective option. As discussed, each of the at least two options may be assigned the weight value. The number of users selecting a particular option for a particular benchmark may be multiplied by a respective weight value. This may be repeated for each at least two options of each one or more benchmarks and the table with weighted results may be made. Next, the weighted total value for each of the options for the particular benchmark may be calculated by summing multiplication (sum product) of the weight value with the number of users of the plurality of users that have selected the respective option. This may be repeated for each of the one or more benchmarks to calculate the weighted total value for each of the one or more benchmarks. Referring to ‘Table 2’, it may be observed that the ‘Table 2’ provides a weighted total value for the ‘user needs analysis survey’ response of ‘Table 1’. For example, referring to ‘Table 1’ and ‘Table 2’, for the benchmark ‘see account balance’, the weighted total value is calculated as:

15×5+3×4+1×3+4×2+7×1=105

In a similar manner, the weighted total value for each of the one or more benchmarks is calculated. The weighted total value may help in determining how important each of the one or more benchmarks is to the plurality of users. Referring to ‘Table 2’, it may be observed that the weighted total value for the benchmark for the service category ‘account balance retrieval’ is highest. Hence, the benchmark for the service category ‘account balance retrieval’ may be included in the digital service for better user experience.

TABLE 2

| | | Very | | | Not | Not at all | Weighted |
|---|---|---|---|---|---|---|---|
| | | important | Important | Neutral | Important | important | Total |
| First service | See account | 75 | 12 | 3 | 8 | 7 | 105 |
| category | balance | | | | | | |
| | Access | 10 | 32 | 15 | 20 | 5 | 82 |
| | statements | | | | | | |
| | See | 35 | 20 | 24 | 12 | 4 | 95 |
| | transactions | | | | | | |
| | Change | 10 | 24 | 45 | 12 | 1 | 92 |
| | statement | | | | | | |
| | delivery | | | | | | |
| Second service | Block Card | 25 | 28 | 15 | 16 | 5 | 89 |
| category | Cancel card | 40 | 8 | 24 | 16 | 4 | 92 |
| | Order new | 20 | 12 | 9 | 10 | 15 | 66 |
| | card | | | | | | |
| | Virtual Card | 30 | 24 | 6 | 30 | 1 | 91 |
| Third services | Pay someone | 0 | 32 | 6 | 10 | 15 | 63 |
| Category | Pay | 25 | 32 | 3 | 8 | 12 | 80 |
| | a bill | | | | | | |
| | Payment | 35 | 12 | 21 | 16 | 5 | 89 |
| | receipt | | | | | | |
| | QR codes | 40 | 36 | 12 | 10 | 4 | 102 |

| | |
|---|---|
| Sum of weighted total value for one or more benchmarks of each service category | 1046 |
| Sum of weighted total value for one or more benchmarks of first service category | 374 |
| Sum of weighted total value for one or more benchmarks of second service category | 338 |
| Sum of weighted total value for one or more benchmarks of third service category | 334 |

The method comprises determining, via the processor, if a particular functionality related with one of the benchmarks of the one or more benchmarks is available in the digital service. Once the ‘user-needs analysis survey’ responses and the total weighted value for each of the one or more benchmarks are obtained, in order to rank the digital service, an analysis is done to determine whether the particular functionality is available or not. A technical effect of obtaining the responses and the total weight value for each of the one or more benchmarks is that the responses are utilised to fully evaluate the availability of the particular functionality, so that there is transparency while determining the digital service score. Such transparency is achieved simultaneously with providing data security and anonymity to users that have provided responses to the system.

Herein, questions such as, “Can I make a payment via a Bank of America?” and “Can I lock my debit card?” may be queried to each of the plurality of users to determine the at least two options and/or to determine the weight value for each of the at least two options. In some embodiments, information scraping may be utilized. Referring to ‘Table 3’, the questions such as, “Can I see account balance for the ‘Bank A’” may be queried from the user. In case the functionality is present in the digital service, the user may select ‘Yes’. Otherwise, the user may select ‘No’.

The method further comprises assigning, via the processor, a benchmark value to each of the one or more benchmarks equal to the calculated weighted total value for the corresponding one of the one or more benchmarks if the related particular functionality thereto is determined to be available in the digital service. Herein, the benchmark value may be defined as the calculated weighted total value if the related particular functionality for the corresponding one of the one or more benchmarks is present and zero if the related particular functionality for the corresponding one of the one or more benchmarks is not present. For example, referring to ‘Table 3’, benchmark values for an exemplary ‘Bank A’ are provided. It may be observed from ‘Table 3’ (below) that the user may see account balance, access statements, virtual card and payment receipt for the ‘Bank A’. However, the user may not see transactions, change statement delivery, block card, cancel card, order new card, pay someone, pay a bill and OR codes for the ‘Bank A’. In order to find benchmark values for the one or more benchmarks where the related particular functionality for the corresponding one of the one or more benchmarks is present, the weighted total value for the corresponding one or more benchmarks may be copied from ‘Table 2’. Benchmark values for the one or more benchmarks where the related particular functionality for the corresponding one of the one or more benchmarks is not present may be zero. Similarly, referring to ‘Table 3’, benchmark values for an exemplary ‘Bank B’ are provided.

TABLE 3

| | | Benchmark |
|---|---|---|
| Benchmark | Functionality available | value |
| See account balance | Yes | 105 |
| Access statements | Yes | 82 |
| See transactions | No | 0 |
| Change | No | 0 |
| statement delivery | | |
| Block card | No | 0 |
| Cancel card | No | 0 |
| Order new card | No | 0 |
| Virtual card | Yes | 91 |
| Pay someone | No | 0 |
| Pay a bill | No | 0 |
| Payment receipt | Yes | 89 |
| OR codes | No | 0 |

| | |
|---|---|
| Sum of assigned benchmark values for each of one or more | 367 |
| benchmarks for each of plurality of service categories | |
| Sum of assigned benchmark values for each of one or more | 187 |
| benchmarks for first service category | |
| Sum of assigned benchmark values for each of one or more | 91 |
| benchmarks for second service category | |
| Sum of assigned benchmark values for each of one or more | 89 |
| benchmarks for third service category | |
| Digital service score | 35.09% |
| Service category score for first service category | 50.00% |
| Service category score for second service category | 26.92% |
| Service category score for third service category | 26.65% |

TABLE 4

| | | Benchmark |
|---|---|---|
| Benchmark | Functionality available | value |
| See account balance | No | 0 |
| Access statements | No | 0 |
| See transactions | No | 0 |
| Change statement delivery | Yes | 92 |
| Block card | Yes | 89 |
| Cancel card | Yes | 92 |
| Order new card | No | 0 |
| Virtual card | No | 0 |
| Pay someone | Yes | 63 |
| Pay a bill | Yes | 80 |
| Payment receipt | Yes | 89 |
| OR codes | Yes | 102 |

| | |
|---|---|
| Sum of assigned benchmark values for each of one or more | 607 |
| benchmarks for each of plurality of service categories | |
| Sum of assigned benchmark values for each of one or more | 92 |
| benchmarks for first service categories | |
| Sum of assigned benchmark values for each of one or more | 181 |
| benchmarks for second service categories | |
| Sum of assigned benchmark values for each of one or more | 334 |
| benchmarks for third service categories | |
| Digital service score | 58.03% |
| Service category score for first service category | 24.60% |
| Service category score for second service category | 53.55% |
| Service category score for third service category | 100.00% |

The method further comprises calculating, via the processor, a digital service score for the digital service based on a sum of the assigned benchmark values for the one or more benchmarks and a sum of the weighted total value for the one or more benchmark. The digital service score couples the availability of functionality with the benchmark value which indicates how important the functionality is to the plurality of users. Herein, each benchmark for the one or more benchmarks may not have the benchmark value of 1, but may have a benchmark value between 0 and X, where X may change depending on ‘user needs analysis survey’ outcomes. The digital service score is calculated by dividing the sum of the assigned benchmark values for the one or more benchmarks by the sum of the weighted total value for the one or more benchmark. The calculated digital service score via the processor provides an unbiased and accurate evaluation means for the method and enables a user to accurately assess the digital service and make informed decisions accordingly. In an example, the user may select a service category with the highest digital service score, wherein the selection may redirect the user to a given webpage of the digital service provider. In another example, the user may discard a particular digital service and opt for a better digital service as indicated by the digital service score.

In an embodiment, the sum of the assigned benchmark values for the one or more benchmarks may be the summation of the assigned benchmark value for each of one or more benchmarks for each of the plurality of service categories. Referring to ‘Table 3’, the sum of the assigned benchmark values for each of the one or more benchmarks for each of the plurality of service categories for ‘Bank A’ is 367 which is calculated by summing the values: 105, 82, 91 and 89. Referring to ‘Table 4’, the sum of the assigned benchmark values for each of the one or more benchmarks for each of the plurality of service categories for ‘Bank B’ is 607 which is calculated by summing the values: 92, 89, 92, 63, 80, 89 and 102.

In an embodiment, the sum of the weighted total value may be the summation of the weighted total value of each of the one or more benchmarks for each service category of the plurality of service categories. For example, referring to ‘Table 2’, the sum of the weighted total value is 1046 which is calculated by summing the values: 105, 82, 95, 92, 89, 92, 66, 91, 63, 80, 89 and 102. Hence, referring to ‘Table 2’ 30 and ‘Table 3’ in combination, the digital service score for ‘Bank A’ may be 0.3509 which is obtained by dividing 367 by 1046. Similarly, referring to ‘Table 2’ and ‘Table 4’ in combination, the digital service score for ‘Bank B’ may be 0.5803.

Optionally, the digital service score for the digital service is calculated as a percentage of the sum of the assigned benchmark values for the one or more benchmarks and the sum of the weighted total value for the one or more benchmarks. Herein, the digital service score for the digital service is calculated as the percentage, with highest possible digital service score being 100% and lowest possible digital service score being 10 0%. The digital service score may be thus calculated by an equation:

digital service score=sum of assigned benchmark values/sum of weighted total value×100

Referring to ‘Table 2’ and ‘Table 3’, the digital service score for the ‘Bank A’ may be 35.09% which may be calculated by assigning the sum of the assigned benchmark values as 367 and the sum of the weighted total value as 1046 in the above equation. Referring to ‘Table 4’ and ‘Table 2’, the digital service score for the ‘Bank B’ may be 58.03% which may be calculated by assigning the sum of the assigned benchmark values as 607 and the sum of the weighted total value as 1046 in the above equation.

Optionally, the method further comprises calculating, via the processor, a service category score for each of the plurality of service categories based on a sum of the assigned benchmark values for the defined benchmarks of a particular service category of the plurality of service categories and a sum of the weighted total value for the defined benchmarks of the said particular service category. The service category score has a similar scoring methodology to the digital service score; however, contrary to the digital service score that may provide overall score for digital service including all the service categories of the plurality of service categories, the service category score may be calculated for each of the service category of the plurality of service categories independently. The service category score may be calculated by dividing the sum of the assigned benchmark values for the defined benchmarks of the particular service category of the plurality of service categories by the sum of the weighted total value for the defined benchmarks of the said particular service category.

It may be appreciated that the sum of the assigned benchmark values for the one or more benchmarks for the particular category may be the summation of the assigned benchmark value for each of one or more benchmarks for the said particular service category of the plurality of service categories. For example, referring to ‘Table 3’, the sum of the assigned benchmark values for each of the one or more benchmarks for the first service category for ‘Bank A’ is 187, the sum of the assigned benchmark values for each of the one or more benchmarks for the second service category for ‘Bank A’ is 91 and the sum of the assigned benchmark values for each of the one or more benchmarks for the third service category for ‘Bank A’ is 89. Similarly, referring to ‘Table 4’, the sum of the assigned benchmark values for each of one or more benchmarks for the first service category for ‘Bank B’ is 92, the sum of the assigned benchmark values for each of one or more benchmarks for the second service category for ‘Bank B’ is 181 and the sum of the assigned benchmark values for each of one or more benchmarks for the third service category for ‘Bank B’ is 334.

It may be appreciated that the sum of the weighted total value for the defined benchmarks of the particular service category may be the summation of the weighted total value of each of the one or more benchmarks for the said service category. For example, referring to ‘Table 2’, the sum of the weighted total value for the first service category is 374 which may be calculated by summing the values: the values: 105, 82, 95 and 92, the sum of the weighted total value for the second service category is 338 which may be calculated by summing the values: 89, 92, 66 and 91 and the sum of the weighted total value for the third service category is 334 which may be calculated by summing the values: 63, 80, 89 and 102. As discussed, the service category score may be calculated for each of the service categories of the plurality of service categories separately. That is, the service category score for the first service category may be obtained by dividing the sum of the assigned benchmark values for the defined benchmarks of the first service category of the plurality of service categories by the sum of the weighted total value for the defined benchmarks of the first service category.

Optionally, the service category score for each of the plurality of service categories is calculated as a percentage of the sum of the assigned benchmark values for the defined benchmarks of a particular service category of the plurality of service categories and the sum of the weighted total value for the defined benchmarks of the said particular service category. Herein, the service category score for each of the plurality of service categories is calculated as the percentage which varies between highest possible service category score being 100% and lowest possible service category score being 0%. The service category score in percentage may be thus calculated by an equation

sum of assigned benchmark values of particular service category/sum of weighted total value of said particular service category×100

Referring to ‘Table 2’ and ‘Table 3’, for the ‘Bank A’, the service category score for the first service category may be 50% which may be calculated by assigning sum of the assigned benchmark values of the first service category as 187 and the sum of the weighted total value of the first service category score as 374 in the above equation. Similarly, for the ‘Bank A’, the service category score for the second service category may be 26.92% and the service category score for the third service category may be 26.65%.

Referring to ‘Table 2’ and ‘Table 4’, for the ‘Bank B’, the service category score for first service category may be 24.60% which may be calculated by assigning sum of the assigned benchmark values of the first service category as 92 and the sum of the weighted total value of the first service category score as 374 in the above equation. Similarly, for the ‘Bank B’, the service category score for the second service category may be 53.55% and the service category score for the third service category may be 100.00%.

Optionally, the method further comprises determining, via the processor, a rank of each of the plurality of service categories in the digital service based on the service category scores thereof. Once the service category scores are obtained for each of the plurality of service categories, the rank may be determined for each of the plurality of service categories. Herein, rank one may be determined for the service category having the highest service category score. For example, referring to ‘Table 3’, the service category score for the first service category may be 50%, the service category score for the second service category may be 26.92% and the service category score for the third service category may be 26.65% for the ‘Bank A’. Hence, for the ‘Bank A’, the first service category may be given rank one, the second service category may be given rank two and the third service category may be given rank three. Similarly, referring to ‘Table 4’, the service category score for the first service category may be 24.60%, the service category score for the second service category may be 53.55% and the service category score for the third service category may be 100% for the ‘Bank B’. Hence, for the ‘Bank B’, the third service category may be given rank one, the second service category may be given rank two and the first service category may be given rank three.

Optionally, the method further comprises:
defining, via the processor, at least two questions for each of the one or more benchmarks for one or more of a plurality of service categories;
defining, via the processor, a question weight value for each of the at least two questions;
receiving, via the processor, from a plurality of users, responses in the form of one of affirmative and negative for each of the at least two questions;
calculating, via the processor, a question weighted total value for each of the at least two questions based on a sum of number of received responses in the affirmative for the corresponding one of the at least two questions and the defined question weight value therefor; and
calculating, via the processor, a category weighting value for each of the plurality of service categories based on a sum of the question weighted total values for the at least two questions of the corresponding service category of the plurality of service categories.

As discussed, the method may further comprise defining at least two questions for each of the one or more benchmarks for one or more of a plurality of service categories. Herein, the question may be related to the plurality of service categories. Next, depending on the questions the question weight value for each of the at least two questions may be defined. Each of the at least two questions may be queried from the plurality of users and responses in the form of one of affirmative or negative for each of the at least two questions may be received to generate data. Furthermore, based on the responses from the plurality of users, a predefined command may be executed. For example, upon achieving a desired score, a popup may be enabled for the user, providing them with a link to the service provider associated with the desired score. Alternatively, upon achieving a desired score, a web page directing to the service provider associated with the desired score may be opened in the user's browser.

Referring to ‘Table 5A’ and ‘Table 5B’, questions from the same ‘user needs analysis survey’ as in ‘Table 1’ are queried from the plurality of users. Herein, thirty (30) users may be asked to respond by rating from first to third one sample question from each of the first service category, the second service category and the third service category. This is done twice, hence, there are two tables: ‘Table 5A’ and ‘Table 5B’. If the question is rated first, it is given the question weight value of three; if the question is rated second, it is given the question weight value of two; and if the question is rated third, it is given the question weight value of one.

TABLE 5A

| Question weight value | | 1 | 2 | 3 | Total |
|---|---|---|---|---|---|
| First service category | See account balance | 20 | 5 | 5 | 30 |
| Second | Block Card | 4 | 11 | 15 | 30 |
| service category | | | | | |
| Third service category | Pay Someone | 2 | 3 | 25 | 30 |

TABLE 5B

| Question weight value | | 1 | 2 | 3 | Total |
|---|---|---|---|---|---|
| First service category | Access Statements | 12 | 4 | 14 | 30 |
| Second | Cancel Card | 11 | 7 | 12 | 30 |
| service category | | | | | |
| Third service category | QR Codes | 5 | 10 | 15 | 30 |

Once the response for each of the at least two questions is received, the method may calculate the question weighted total value for each of the at least two questions based on the sum of number of received responses in the affirmative for the corresponding one of the at least two questions and the defined question weight value therefor. For example, referring to ‘Table 5A’ and ‘Table 5B’, the question weighted total value for the first service category when the first service category is rated third may be 32 which may be calculated by multiplying the sum of number of received responses which is 32 with the defined question weight value which is one for the third rate. Similarly, question weighted total value for the first service category when the first service category is rated second may be 18 which may be calculated by multiplying the sum of number of received responses which is nine with the defined question weight value which is two for the second rank. Referring to ‘Table 6’, sum of question weighted total value for each of the plurality of service categories of ‘Table 5A’ and ‘Table 5B’ is shown. The sum of question weighted total value for the first service category may be 107 which may be obtained by adding 32, 18 and 57. Similarly, the sum of question weighted total value for the second service category may be 132 and the sum of question weighted total value for the third service category may be 153.

TABLE 6

| Question | | | | Sum of question | Category |
|---|---|---|---|---|---|
| weight value | 1 | 2 | 3 | weighted total value | weighting value |
| First | 32 | 18 | 57 | 107 | 27.30% |
| service category | | | | | |
| Second | 15 | 36 | 81 | 132 | 33.67% |
| service category | | | | | |
| Third | 7 | 26 | 120 | 153 | 39.03% |
| service category | | | | | |
| | | | | 392 | 100.00% |

Next, the method may calculate the category weighting value for each of the plurality of service categories based on the sum of the question weighted total values for the at least two questions of the corresponding service category of the plurality of service categories. Herein, the category weighting value for each of the plurality of service categories may be calculated by summing the question weighted total values for the respective service category. In an embodiment, the category weighting value for each of the plurality of service categories may be found in terms of percentage which may be calculated by the following equation:

$$\frac{\begin{matrix}sum of the question weighted total values \\ for one service category\end{matrix}}{\begin{matrix}sum of the question weighted total values \\ for each of the service category\end{matrix}} \times 100$$

For example, referring to ‘Table 6’, the category weighting value for the plurality of service categories are calculated. Herein, the sum of the question weighted total values for the first service category may be 107 and the sum of the question weighted total values for all the three service categories is 392. The category weighting value in percentage may be 27.30 for the first service category which may be calculated by using 107 for sum of the question weighted total values for one service category and 392 for sum of the question weighted total values for each of the service categories in the above equation.

Optionally, the method further comprises calculating, via the processor, a category weighted digital service score for the digital service based on a sum of multiplications of the service category score and the category weighting value for each of the plurality of service categories. Contrary to the digital service score which is calculated according to the questions, the category weighted digital service score incorporates the category weighting value to the digital service score, and may be used to calculate overall score (as opposed to a category score, as the weighting sits at the category level).

Referring to ‘Table 6’ and ‘Table 7’, ‘user-needs analysis survey’ results for the ‘Bank A’ and ‘Bank B’ have been reviewed to illustrate which functionality they offer. ‘Function available’ column indicates ‘Yes’ if the benchmark is available and ‘NO’ if it is not available. Herein, the category weighted digital service score may be calculated by summing multiplication (sum product) of service category score for each service category with the respective category weighting value. Referring to ‘Table 6’ and ‘Table 7’, the category weighted digital service score for the ‘Bank A’ may be 0.3311 which may be calculated as:

0.2730×0.50+0.3367×0.2692+0.3903×0.2665

Similarly, referring to ‘Table 6’ and ‘Table 8’, the category weighted digital service score for the ‘Bank B’ may be 0.6378.

Optionally, the category weighted digital service score for the digital service is calculated as a percentage of the sum of multiplications of the service category score and the category weighting value for each of the plurality of service categories. Herein, referring to ‘Table 7’ and ‘Table 8’, category weighted digital service scores such as 0.3311 for ‘Bank A’ and 0.6378 for ‘Bank B’ may be multiplied by 100. Hence, the category weighted digital service score for the ‘Bank A’ may be 33.11% and the category weighted digital service score for the ‘Bank B’ may be 63.78%.

TABLE 7

| Function available? | Value |
|---|---|
| Yes | 105 |
| Yes | 82 |
| No | 0 |
| No | 0 |
| No | 0 |
| No | 0 |
| No | 0 |
| Yes | 91 |
| No | 0 |
| No | 0 |
| Yes | 89 |
| No | 0 |
| Category weighted | 33.11% |
| digital service score | |
| Service category score | 50.00% |
| for first service | |
| category | |
| Service category score | 26.92% |
| for second service | |
| category | |
| Service category score | 26.65% |
| for third service | |
| category | |
| Digital service index | 33.33% |
| Service category index | 50.00% |
| for first service | |
| category | |
| Service category index | 25.00% |
| for second service | |
| category | |
| Service category index | 25.00% |
| for third service | |
| category | |

TABLE 8

| Function available? | Value |
|---|---|
| No | 0 |
| No | 0 |
| No | 0 |
| Yes | 92 |
| Yes | 89 |
| Yes | 92 |
| No | 0 |
| No | 0 |
| Yes | 63 |
| Yes | 80 |
| Yes | 89 |
| Yes | 102 |
| Category weighted | 63.78% |
| digital service score | |
| Service category score | 24.60% |
| for first service category | |
| Service category score | 53.55% |
| for second service | |
| category | |
| Service category score | 100.00% |
| for third service | |
| category | |
| Digital service index | 58.33% |
| Service category index | 25.00% |
| for first service category | |
| Service category index | 50.00% |
| for second service | |
| category | |
| Service category index | 100.00% |
| for third service category | |

Optionally, the method further comprises calculating, via the processor, a digital service index as a percentage of number of functionalities related with the one or more benchmarks available in the digital service and a total number of the one or more defined benchmarks therefor. The method may provide the digital service index in percentage, with the highest possible digital service index being 100% and lowest digital service index being 0%. The digital service index is intended to provide a view of what percentage of one or more benchmarks are offered by the provider in the digital service channel such as, but not limited to, mobile application, desktop application, tablet application, desktop web or mobile web. Herein, each one or more benchmark has a value of 1. The digital service index may be calculated by the following equation:

$$\frac{number of functionalities available in digital service}{total number of one or more defined benchmarks} \times 100$$

As discussed, in order to determine if the particular functionality related with one of the benchmarks of the one or more benchmarks is available in the digital service, questions may be queried from the user. The response of the user may then be noted down to calculate the digital service index. Referring to ‘Table 7’, the number of functionalities available in the ‘Bank A’ is four and the total number of the one or more defined benchmarks is twelve; hence, the digital service index for the ‘Bank A’ may be 33.33%. Similarly, referring to ‘Table 8’, the digital service index for the ‘Bank B’ may be calculated as 58.33%.

Optionally, the method further comprises calculating, via the processor a service category index as a percentage of number of functionalities related with the one or more benchmarks available in a particular service category of the plurality of service categories and a total number of the defined benchmarks of the one or more benchmarks in the said particular service category. The service category index may have a similar scoring methodology as the digital service index. However, contrary to the digital service index, the service category index may be calculated for the particular service category and not for the digital service including all the plurality of service categories at once. That is, the service category index may be calculated by the following equation:

$$\frac{\begin{matrix}number of functionalities available in \\ particular service category \times 100\end{matrix}}{\begin{matrix}total number of one or more defined benchmarks \\ in particular service category\end{matrix}}$$

For example, referring to ‘Table 7’, for the first service category, the number of functionalities available in the first category may be two and the total number of the one or more defined benchmarks in the first service category may be four. Hence, the service category index for the first category for the ‘Bank A’ may be 50%. Similarly, the service category index for the second category for the ‘Bank A’ may be 25% and the service category index for the third category for the ‘Bank A’ may be 25%.

It may be noted that the digital service index attributes an equal value to each benchmark. While the digital service index is not unique, the one or more benchmarks measured are. Coupling this information with data from the ‘user needs analysis survey’ response allows the one or more benchmarks to be weighted to become the digital service score or the category weighted digital service score, both of which may be unique and may measure how well the digital services addresses customer wants or needs, as discussed above.

Moreover, the present description also relates to a system for evaluating the digital service as described above. The various embodiments and variants disclosed above apply mutatis mutandis to the system for evaluating the digital service.

Optionally, the processor is further configured to calculate a service category score for each of the plurality of service categories based on a sum of the assigned benchmark values for the defined benchmarks of a particular service category of the plurality of service categories and a sum of the weighted total value for the defined benchmarks of the said particular service category.

Optionally, the processor is further configured to define at least two questions for each of the one or more benchmarks for one or more of a plurality of service categories, define a question weight value for each of the at least two questions, receive from a plurality of users responses in the form of one of affirmative and negative for each of the at least two questions, calculate a question weighted total value for each of the at least two questions based on a sum of number of received responses in the affirmative for the corresponding one of the at least two questions and the defined question weight value therefor and calculate a category weighting value for each of the plurality of service categories based on a sum of the question weighted total values for the at least two questions of the corresponding service category of the plurality of service categories.

Optionally, the processor is further configured to calculate a digital service index as a percentage of number of functionalities related with the one or more benchmarks available in the digital service and a total number of the one or more defined benchmarks therefor.

Optionally, the processor is further configured to calculate a service category index as a percentage of number of functionalities related with the one or more benchmarks available in a particular service category of the plurality of service categories and a total number of the defined benchmarks of the one or more benchmarks in the said particular service category.

It may be noted that the system and the method may be implemented on a cloud-based platform built in a highly scalable and modular way to calculate, filter and sort, render, categorize and compare benchmarks which may be elements of user experience. In an embodiment, the system and the method may cater for banking and insurance. In an alternative embodiment, the system and the method may be used in sectors other than banking and insurance. The system and the method may be modular due to the decoupled nature of logic and data from the user interface (UI). The system and the method may be based on Amazon Web Services (AWS), for example, and all functionality may be handheld through AWS Lambda where each piece of logic or calculation is coded as a separate Lambda function.

These Lambda functions may be serverless entities that allow them to scale almost infinitely. In order to compliment the scale, the system and the method uses AWS Content Delivery Network (CDN), for example, and to continue modularity at a front end, the user interface (UI) is also built as a series of standalone components such as, graphs, filters and content block that may be swapped with ease.

The system and the method are advantageous as they help in aggregation and comparison of industry vertical interfaces in a meaningful way. Moreover, the system and the method may empower providers to inform their team members, learn about their industry and compare with others.

### DETAILED DESCRIPTION OF DRAWINGS

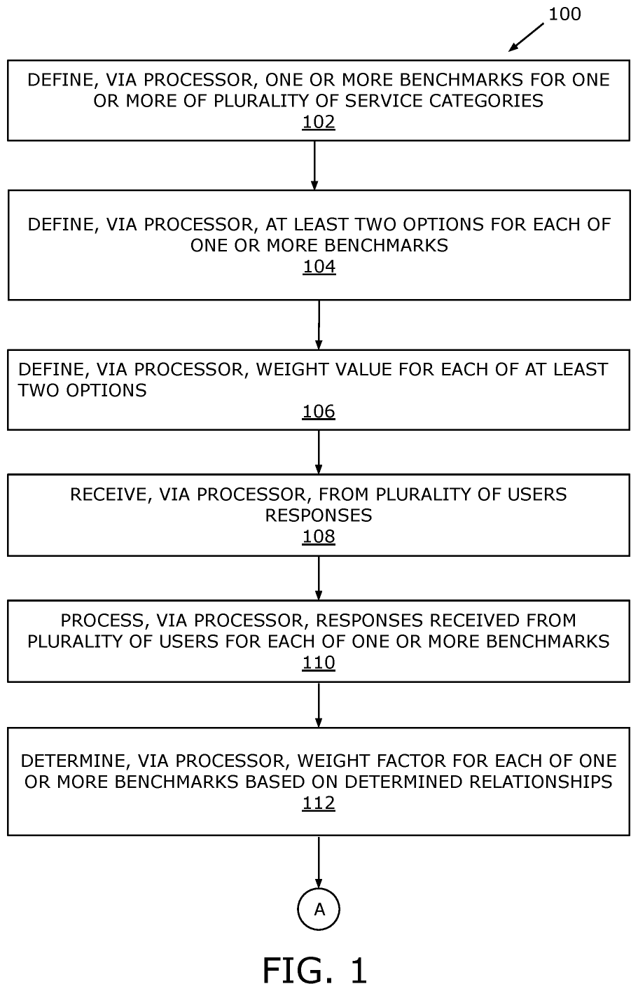

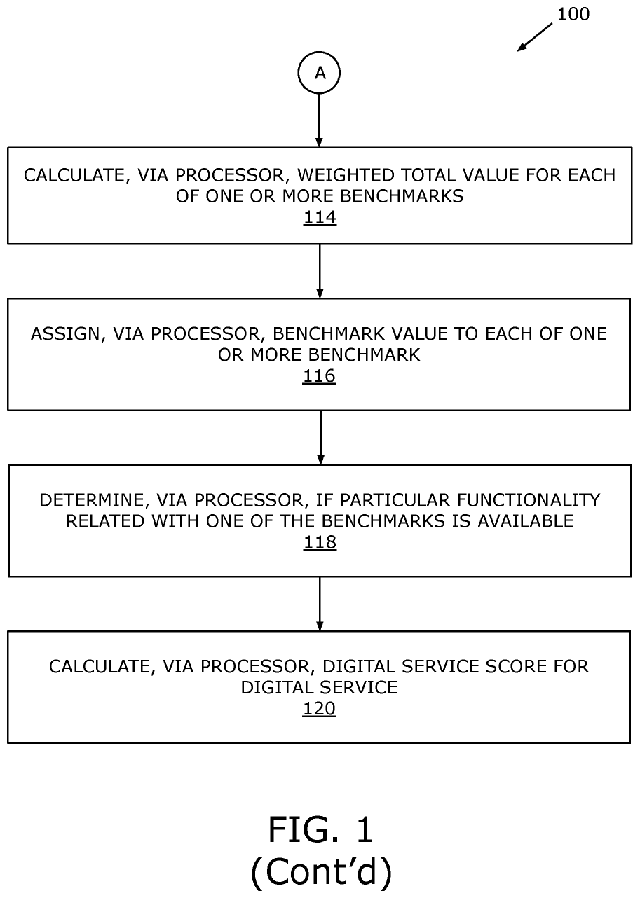

Referring to FIG. 1, there is shown a flowchart listing steps involved in a method 100 for evaluating a digital service, in accordance with an embodiment of the present disclosure. The method 100 comprises, at step 102, defining, via a processor, one or more benchmarks for one or more of a plurality of service categories associated with the digital service. Herein, each of the one or more benchmarks is related to a functionality offered by the corresponding service category of the plurality of service categories from the perspective of a user. The method 100 further comprises, at step 104, defining, via the processor, at least two options for each of the one or more benchmarks. Herein, one of the at least two options is to be selected as a response by a user for each of the one or more benchmarks as an indicator of importance of the functionality offered by the related benchmark of the one or more benchmarks from the perspective of the said user. The method 100 further comprises, at step 106, defining, via the processor, a weight value for each of the at least two options. Herein, the weight value for each of the at least two options is defined proportional to an importance of the functionality offered by the related benchmark of the one or more benchmarks from the perspective of a user. The method 100 further comprises, at step 108, receiving, via the processor, from a plurality of users, responses. Herein, the responses are received in the form of selection of one of the at least two options for each of the one or more benchmarks. The method 100 further comprises, at step 110, processing, via the processor, the responses received from the plurality of users for each of the one or more benchmarks based on at least the defined weight values of the selected at least two options and the associated service category to determine relationships between the one or more benchmarks, or between at least one of the one or more benchmarks and the corresponding service category. The received responses are processed to determine useful relationships or data therefrom. The method 100 further comprises, at step 112, determining, via the processor, a weight factor for each of the one or more benchmarks based on the determined relationships between the one or more benchmarks, or between at least one of the one or more benchmarks and the corresponding service category. The method 100 further comprises, at step 114, calculating, via the processor, a weighted total value for each of the one or more benchmarks. Herein, the weighted total value for each of the one or more benchmarks is calculated based on the received responses and the defined weight values for the at least two options thereof. The method 100 comprises, at step 116, determining, via the processor, if a particular functionality related with one of the benchmarks of the one or more benchmarks is available in the digital service. The method 100 comprises, at step 118, assigning, via the processor, a benchmark value to each of the one or more benchmarks. Herein, the assigned benchmark value is equal to the calculated weighted total value for the corresponding one of the one or more benchmarks if the related particular functionality thereto is determined to be available in the digital service. The method 100 comprises, at step 120, calculating, via the processor, a digital service score for the digital service. Herein, the digital service score for the digital service may be calculated based on a sum of the assigned benchmark values for the one or more benchmarks and a sum of the weighted total value for the one or more benchmarks.

The aforementioned steps are only illustrative and other alternatives can also be provided where one or more steps are added, one or more steps are removed, or one or more steps are provided in a different sequence without departing from the scope of the claims herein.

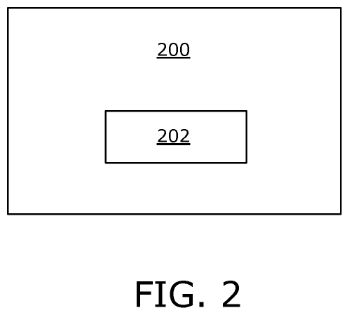

Referring to FIG. 2, there is shown a schematic illustration of a system 200 for evaluating the digital service, in accordance with an embodiment of the present disclosure. The system 200 comprises a processor 202. The processor 202 is configured to define one or more benchmarks for one or more of the pluralities of service categories associated with the digital service. Herein, each of the one or more benchmarks is related to the functionality offered by the corresponding service category of the plurality of service categories from the perspective of the user. The processor 202 is further configured to define at least two options for each of the one or more benchmarks, with one of the at least two options to be selected as the response by the user for each of the one or more benchmarks as the indicator of importance of the functionality offered by the related benchmark of the one or more benchmarks from perspective of the said user. The processor 202 is further configured to define the weight value for each of the at least two options proportional to an importance of the functionality offered by the related benchmark of the one or more benchmarks from the perspective of the user. The processor 202 is further configured to receive, from the plurality of users, responses in the form of selection of one of the at least two options for each of the one or more benchmarks. The processor 202 is further configured to calculate the weighted total value for each of the one or more benchmarks based on the received responses and the defined weight values for the at least two options thereof. The processor 202 is further configured to determine if the particular functionality related with one of the benchmarks of the one or more benchmarks is available in the digital service. The processor 202 is further configured to assign the benchmark value to each of the one or more benchmarks equal to the calculated weighted total value for the corresponding one of the one or more benchmarks if the related particular functionality thereto is determined to be available in the digital service. The processor 202 is further configured to calculate a digital service score for the digital service based on the sum of the assigned benchmark values for the one or more benchmarks and the sum of the weighted total value for the one or more benchmarks.

FIG. 2 is merely an example, which should not unduly limit the scope of the claims herein. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

What we claim is:

1. A method for evaluating a digital service, the method comprising:
defining, via a processor, one or more benchmarks for one or more of a plurality of service categories associated with the digital service, each of the one or more benchmarks related to a functionality offered by corresponding service category of the plurality of service categories from perspective of a user;
defining, via the processor, at least two options for each of the one or more benchmarks, with one of the at least two options to be selected as a response by a user for each of the one or more benchmarks as an indicator of importance of the functionality offered by the related benchmark of the one or more benchmarks from perspective of the said user;
defining, via the processor, a weight value for each of the at least two options proportional to an importance of the functionality offered by the related benchmark of the one or more benchmarks from perspective of a user;
receiving, via the processor, from a plurality of users, responses in the form of selection of one of the at least two options for each of the one or more benchmarks; —processing, via the processor, the responses received from the plurality of users for each of the one or more benchmarks based on at least the defined weight values of the selected at least two options and the associated service category to determine relationships between the one or more benchmarks, or between at least one of the one or more benchmarks and the corresponding service category;
determining, via the processor, a weight factor for each of the one or more benchmarks based on the determined relationships between the one or more benchmarks, or between at least one of the one or more benchmarks and the corresponding service category;
calculating, via the processor, a weighted total value for each of the one or more benchmarks based on the received responses and the defined weight values for the at least two options thereof;
determining, via the processor, if a particular functionality related with one of the benchmarks of the one or more benchmarks is available in the digital service;
assigning, via the processor, a benchmark value to each of the one or more benchmarks equal to the calculated weighted total value for the corresponding one of the one or more benchmarks if the related particular functionality thereto is determined to be available in the digital service; and
calculating, via the processor, a digital service score for the digital service based on a sum of the assigned benchmark values for the one or more benchmarks and a sum of the weighted total value for the one or more benchmarks.

2. The method according to claim 1, further comprising calculating, via the processor, a service category score for each of the plurality of service categories based on a sum of the assigned benchmark values for the defined benchmarks of a particular service category of the plurality of service categories and a sum of the weighted total value for the defined benchmarks of the said particular service category.

3. The method according to claim 2, further comprising:
defining, via the processor, at least two questions for each of the one or more benchmarks for one or more of a plurality of service categories;
defining, via the processor, a question weight value for each of the at least two questions;
receiving, via the processor, from a plurality of users, responses in the form of one of affirmative and negative for each of the at least two questions;
calculating, via the processor, a question weighted total value for each of the at least two questions based on a sum of number of received responses in the affirmative for the corresponding one of the at least two questions and the defined question weight value therefor; and
calculating, via the processor, a category weighting value for each of the plurality of service categories based on a sum of the question weighted total values for the at least two questions of the corresponding service category of the plurality of service categories.

4. The method according to claim 3, further comprising calculating, via the processor, a category weighted digital service score for the digital service based on a sum of multiplications of the service category score and the category weighting value for each of the plurality of service categories.

5. The method according to claim 1, wherein the digital service score for the digital service is calculated, via the processor, as a percentage of the sum of the assigned benchmark values for the one or more benchmarks and the sum of the weighted total value for the one or more benchmarks.

6. The method according to claim 2, wherein the service category score for each of the plurality of service categories is calculated as a percentage of the sum of the assigned benchmark values for the defined benchmarks of a particular service category of the plurality of service categories and the sum of the weighted total value for the defined benchmarks of the said particular service category.

7. The method according to claim 4, wherein the category weighted digital service score for the digital service is calculated as a percentage of a sum of multiplications of the service category score and the category weighting value for each of the plurality of service categories.

8. The method according to claim 1, further comprising determining, via the processor, a rank of each of the plurality of service categories in the digital service based on the service category scores thereof.

9. The method according to claim 1, further comprising calculating, via the processor, a digital service index as a percentage of number of functionalities related with the one or more benchmarks available in the digital service and a total number of the one or more defined benchmarks therefor.

10. The method according to claim 1, further comprising calculating, via the processor, a service category index as a percentage of number of functionalities related with the one or more benchmarks available in a particular service category of the plurality of service categories and a total number of the defined benchmarks of the one or more benchmarks in the said particular service category.

11. A system for evaluating a digital service, the system comprising a processor configured to:
define one or more benchmarks for one or more of a plurality of service categories associated with the digital service, each of the one or more benchmarks related to a functionality offered by corresponding service category of the plurality of service categories from perspective of a user;
define at least two options for each of the one or more benchmarks, with one of the at least two options to be selected as a response by a user for each of the one or more benchmarks as an indicator of importance of the functionality offered by the related benchmark of the one or more benchmarks from perspective of the said user;
define a weight value for each of the at least two options proportional to an importance of the functionality offered by the related benchmark of the one or more benchmarks from perspective of a user;
receive, from a plurality of users, responses in the form of selection of one of the at least two options for each of the one or more benchmarks;
process the responses received from the plurality of users for each of the one or more benchmarks based on at least the defined weight values of the selected at least two options and the associated service category to determine relationships between the one or more benchmarks, or between at least one of the one or more benchmarks and the corresponding service category;
determine a weight factor for each of the one or more benchmarks based on the determined relationships between the one or more benchmarks, or between at least one of the one or more benchmarks and the corresponding service category;
calculate a weighted total value for each of the one or more benchmarks based on at least one of the received responses, the determined weight factor, and the defined weight values for the at least two options thereof;
determine if a particular functionality related with one of the benchmarks of the one or more benchmarks is available in the digital service;
assign a benchmark value to each of the one or more benchmarks equal to the calculated weighted total value for the corresponding one of the one or more benchmarks if the related particular functionality thereto is determined to be available in the digital service; and
calculate a digital service score for the digital service based on a sum of the assigned benchmark values for the one or more benchmarks and a sum of the weighted total value for the one or more benchmarks.

12. The system according to claim 11, wherein the processor is further configured to calculate a service category score for each of the plurality of service categories based on a sum of the assigned benchmark values for the defined benchmarks of a particular service category of the plurality of service categories and a sum of the weighted total value for the defined benchmarks of the said particular service category.

13. The system according to claim 12, wherein the processor is further configured to:
define at least two questions for each of the one or more benchmarks for one or more of a plurality of service categories;
define a question weight value for each of the at least two questions;
receive, from a plurality of users, responses in the form of one of affirmative and negative for each of the at least two questions;
calculate a question weighted total value for each of the at least two questions based on a sum of number of received responses in the affirmative for the corresponding one of the at least two questions and the defined question weight value therefor; and
calculate a category weighting value for each of the plurality of service categories based on a sum of the question weighted total values for the at least two questions of the corresponding service category of the plurality of service categories.

14. The system according to claim 10, wherein the processor is further configured to calculate a digital service index as a percentage of number of functionalities related with the one or more benchmarks available in the digital service and a total number of the one or more defined benchmarks therefor.

15. The system according to claim 10, wherein the processor is further configured to calculate a service category index as a percentage of number of functionalities related with the one or more benchmarks available in a particular service category of the plurality of service categories and a total number of the defined benchmarks of the one or more benchmarks in the said particular service category.
